(19) United States
(12) Patent Application Publication
(10) Pub. No.: US 2017/0182684 A1
(43) Pub. Date: Jun. 29, 2017

(54) METHOD OF VERIFYING REMOVAL OF A PEEL PLY MATERIAL FROM A COMPOSITE STRUCTURE AND DOPED PEEL PLY ASSEMBLY

(71) Applicant: SIKORSKY AIRCRAFT CORPORATION, Statford, CT (US)

(72) Inventors: Jonathan K. Garhart, Seymour, CT (US); Eric K. Hansen, North Branford, CT (US)

(21) Appl. No.: 15/389,692

(22) Filed: Dec. 23, 2016

Related U.S. Application Data
(60) Provisional application No. 62/272,452, filed on Dec. 29, 2015.

(51) Int. Cl. B29C 37/00; B29C 70/54

(52) U.S. Cl. CPC B29C 37/00; B29C 70/54; B29C 2037/80; B29C 2037/90

(57) ABSTRACT

A method of verifying removal of peel ply material from a composite structure is provided. The method includes doping a layer of peel ply fabric with an identifier. The method also includes curing the composite structure with the layer of peel ply fabric disposed on a surface of the composite structure. The method further includes removing the layer of peel ply fabric from the surface. The method yet further includes scanning the surface of the composite structure for the identifier.

### CROSS REFERENCE TO RELATED APPLICATIONS

This application claims the benefit of Provisional Application No. 62/272,452, filed Dec. 29, 2015, the contents of which are incorporated by reference in its entirety herein.

### BACKGROUND

The embodiments herein relate to composite structures and, more particularly, a method of verifying complete removal of a peel ply material from a composite structure, as well as structures associated therewith.

Composite components that will be bonded after cure are commonly cured with a layer of peel ply fabric on the surface in order to protect the surface from contamination and oxidation, both of which would cause less than optimal bond strength. The part is prepared for bonding by removing this peel ply. Removal of the peel ply after cure leaves a fresh surface protected from release contamination and matrix material that has not been exposed to an oxidizing atmosphere. However, there are circumstances in which the peel ply itself leaves residual fibers on the surface of the part and these fibers will degrade the bond strength. These fibers can be detected through burdensome microscopic inspection which is costly and time consuming. Additionally, bulk detection processes may include scanning, but these processes have proven impractical as the molecular signature of the peel ply fabric is difficult to differentiate from the composite matrix material.

### BRIEF DESCRIPTION

According to one embodiment, a method of verifying removal of peel ply material from a composite structure is provided. The method includes doping the constituent fiber used to fabricate a layer of peel ply fabric with an identifier. The method involves curing the composite structure along with the layer of doped peel ply fabric on its surface. The method further includes removing the layer of peel ply fabric from the surface. The method yet further includes scanning the surface of the composite structure for the identifier so that its complete removal can be verified.

In addition to one or more of the features described above, or as an alternative, further embodiments may include that the identifier comprises magnetic particles.

In addition to one or more of the features described above, or as an alternative, further embodiments may include that doping the layer of peel ply fabric with magnetic particles comprises mixing microscopic magnetic particles into a precursor thermoplastic used to manufacture the layer of peel ply fabric.

In addition to one or more of the features described above, or as an alternative, further embodiments may include that scanning the surface of the composite structure for the identifier comprises scanning the surface with a magnetic detector.

In addition to one or more of the features described above, or as an alternative, further embodiments may include that the identifier comprises a substance having ultraviolet light properties.

In addition to one or more of the features described above, or as an alternative, further embodiments may include that scanning the surface of the composite structure for the identifier comprises scanning the surface with an ultraviolet light detector.

In addition to one or more of the features described above, or as an alternative, further embodiments may include that the identifier comprises a substance having differentiated x-ray density properties.

In addition to one or more of the features described above, or as an alternative, further embodiments may include scanning the surface of the composite structure for the x-ray identifier using an x-ray machine or a fluoroscope.

In addition to one or more of the features described above, or as an alternative, further embodiments may include that doping the layer of peel ply fabric with an identifier is done during manufacture of the layer of peel ply fabric.

In addition to one or more of the features described above, or as an alternative, further embodiments may include that doping the layer of peel ply fabric with an identifier is done during a post-manufacture process.

According to another embodiment, a peel ply fabric assembly includes a layer of peel ply fabric disposable over a surface of a composite structure during curing. The assembly also includes an identifier integrated with the layer and detectable for portions of the layer left on the surface of the composite structure.

In addition to one or more of the features described above, or as an alternative, further embodiments may include that the identifier comprises a plurality of magnetic particles.

In addition to one or more of the features described above, or as an alternative, further embodiments may include that the identifier comprises a substance having ultraviolet light properties.

In addition to one or more of the features described above, or as an alternative, further embodiments may include that the identifier comprises a substance having differentiated x-ray properties.

In addition to one or more of the features described above, or as an alternative, further embodiments may include that the identifier is disposed within the layer.

### BRIEF DESCRIPTION OF THE DRAWINGS

The subject matter which is regarded as the present disclosure is particularly pointed out and distinctly claimed in the claims at the conclusion of the specification. The foregoing and other features and advantages of the present disclosure are apparent from the following detailed description taken in conjunction with the accompanying drawings in which:

FIG. 1 is a view of a layer of peel ply material being removed from a composite structure with residual peel ply material left on the surface; and

FIG. 2 is a flow diagram illustrating a method of verifying removal of peel ply material from the surface of the composite structure.

### DETAILED DESCRIPTION

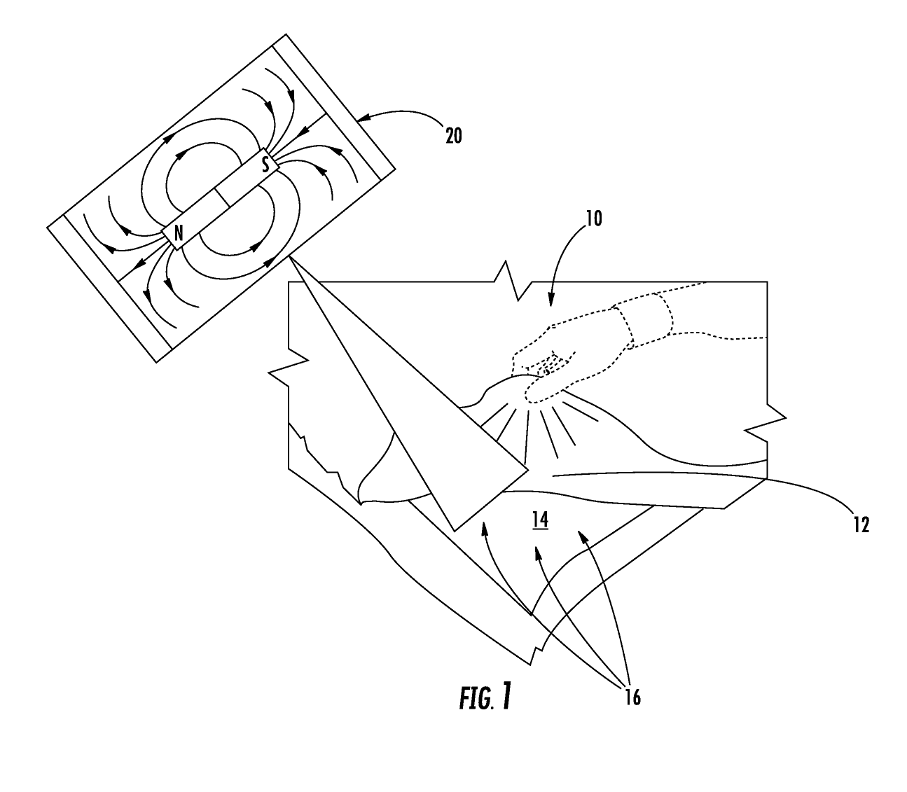

Referring to FIG. 1, a composite structure is illustrated and is referenced generally with numeral 10. The composite structure 10 may be formed of numerous contemplated materials utilized in composites. Additionally, the composite structure 10 described herein may be employed in any application that benefits from the use of a composite structure. In some embodiments, the composite structure 10 is employed in the aerospace industry, such as in association with a rotary wing aircraft, for example.

The composite structure 10 is illustrated with a layer of peel ply fabric 12 disposed on a surface 14 of the composite structure 10. The layer of peel ply fabric 12 is disposed on the surface 14 during curing of the composite structure 10. Subsequently, the layer of peel ply fabric 12 is removed from the surface 14 in preparation for a bonding operation involving the surface 14 of the composite structure 10. To avoid disadvantages associated with peel ply fabric residue being left on the surface 14, the layer of peel ply fabric 12 is doped with an identifier 16 that more efficiently identifies such residue. The layer of peel ply fabric 12 and a method associated with verifying removal of the layer 12 is described herein.

The layer of peel ply fabric 12 may be doped with any identifier that facilitates more efficient residue scanning of the surface 14 of the composite structure 10. Regardless of the particular identifier introduced into the layer of peel ply fabric 12, it is to be appreciated that the identifier may be incorporated therewith in any suitable manner and at any stage of manufacturing. For example, the identifier 16 may be integrally formed with the layer 12 during manufacture, such as by mixing the identifier with the layer of peel ply fabric 12. In some embodiments, the identifier 16 is thoroughly and homogeneously integrated in the peel ply material, such that any residue left behind would be certain to contain the dopant at an identifiable level.

In one embodiment, the identifier 16 comprises a plurality of magnetic particles. In such an embodiment, the magnetic particles may be integrated with the layer of peel ply fabric 12 by mixing microscopic magnetic particles into a precursor thermoplastic used to manufacture the layer of peel ply fabric 12. In a magnetic particle embodiment, the surface 14 of the composite structure 10 is scanned with a magnetic detector 20. The composite structure 10 is non-magnetic, thereby allowing confirmation of the presence of residual peel ply fabric upon detection of magnetic particles with the magnetic detector 20. The surface 14 of the composite structure 10 may then be treated at the detection location to remove the peel ply fabric.

As discussed above, alternative identifiers may be employed. In another embodiment, the layer of peel ply fabric 12 may include a substance having ultraviolet light properties. In such an embodiment, the scanner 20 is an ultraviolet light detector configured to detect the presence of peel ply fabric left on the surface 14 of the composite structure 10.

In yet another embodiment, the layer of peel ply fabric 12 may include a substance having differentiated x-ray properties. In such an embodiment, the scanner 20 is an x-ray scanner or fluoroscope configured to detect the presence of peel ply fabric left on the surface 14 of the composite structure 10.

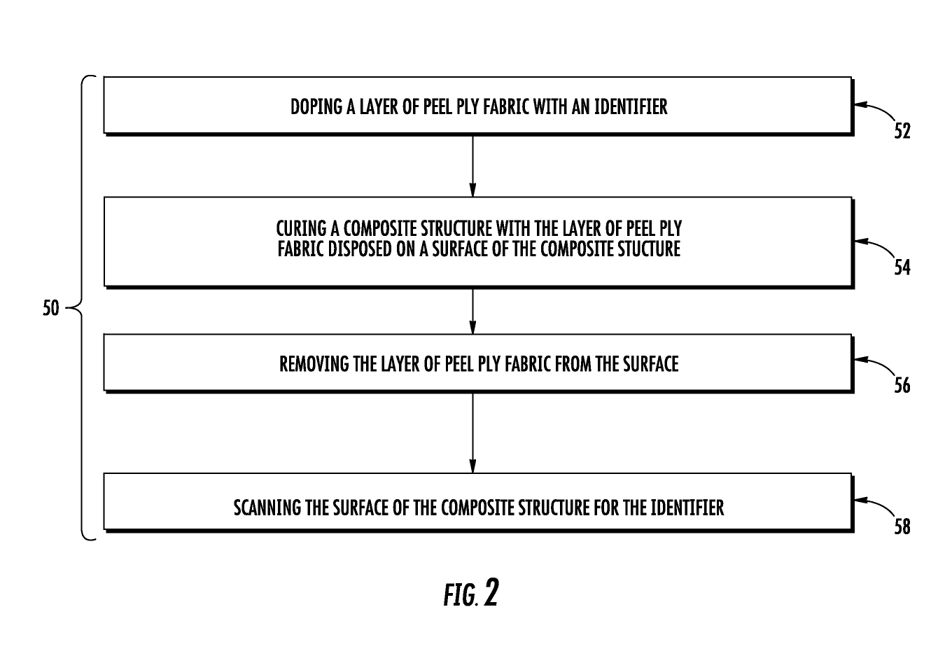

Referring now to FIG. 2, a method 50 of verifying at least substantial, or complete, removal of peel ply material from the composite structure 10 is illustrated in the flow diagram. The method includes doping 52 the layer of peel ply fabric 12 with the identifier 16. The composite structure 10 is then cured 54 with the layer of peel ply fabric 12 disposed on the surface 14 of the composite structure 10. The layer of peel ply fabric 12 is then removed 56 from the surface 14. The surface 14 of the composite structure 10 is then scanned 58 for the identifier 16 to determine if peel ply fabric residue was left during the peel ply removal process.

Advantageously, the layer of peel ply fabric 12 and the method 50 disclosed herein allow large surface areas of the composite structure 10 to be inspected for peel ply residue in a wide scan approach that is efficient and reliable. By doping the layer of peel ply fabric with the identifier 16, costly and time consuming inspection practices are avoided.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of verifying removal of peel ply material from a composite structure comprising:
doping a layer of peel ply fabric with an identifier;
curing the composite structure with the layer of peel ply fabric disposed on a surface of the composite structure;
removing the layer of peel ply fabric from the surface; and
scanning the surface of the composite structure for the identifier.

2. The method of claim 1, wherein the identifier comprises magnetic particles.

3. The method of claim 2, wherein doping the layer of peel ply fabric with magnetic particles comprises mixing microscopic magnetic particles into a precursor thermoplastic used to manufacture the layer of peel ply fabric.

4. The method of claim 2, wherein scanning the surface of the composite structure for the identifier comprises scanning the surface with a magnetic detector.

5. The method of claim 1, wherein the identifier comprises a substance having ultraviolet light properties.

6. The method of claim 5, wherein scanning the surface of the composite structure for the identifier comprises scanning the surface with an ultraviolet light detector.

7. The method of claim 1, wherein the identifier comprises a substance having differentiated x-ray properties.

8. The method of claim 7, wherein scanning the surface of the composite structure for the identifier comprises scanning the surface with at least one of an x-ray scanner and a fluoroscope.

9. The method of claim 1, wherein doping the layer of peel ply fabric with an identifier is done during manufacture of the layer of peel ply fabric.

10. A peel ply fabric assembly comprising:
a layer of peel ply fabric disposable over a surface of a composite structure during curing; and
an identifier integrated with the layer and detectable for portions of the layer left on the surface of the composite structure.

11. The peel ply fabric assembly of claim 10, wherein the identifier comprises a plurality of magnetic particles.

12. The peel ply fabric assembly of claim 10, wherein the identifier comprises a substance having ultraviolet light properties.

13. The peel ply fabric assembly of claim 10, wherein the identifier comprises a substance having differentiated x-ray properties.

14. The peel ply fabric assembly of claim 10, wherein the identifier is disposed within the layer.
